(19) United States
(12) Patent Application Publication
(10) Pub. No.: US 2025/0266537 A1
(43) Pub. Date: Aug. 21, 2025

(54) RECHARGEABLE BATTERY

(71) Applicant: Samsung SDI Co., Ltd., Yongin-si (KR)

(72) Inventor: Youngkwang Yun, Yongin-si (KR)

(73) Assignee: Samsung SDI Co., Ltd., Yongin-si (KR)

(21) Appl. No.: 18/926,220

(22) Filed: Oct. 24, 2024

(30) Foreign Application Priority Data
Feb. 15, 2024 (KR) 10-2024-0022153

(51) Int. Cl. H01M 50/121; H01M 50/124; H01M 50/14

(52) U.S. Cl. CPC H01M 50/121; H01M 50/124; H01M 50/14

(57) ABSTRACT

A rechargeable battery is provided. The rechargeable battery may include an electrode assembly including a first electrode plate, a second electrode plate, and a separator interposed between the first electrode plate and the second electrode plate, and a protection member having a Bouligand structure, and configured to surround the electrode assembly and protect the electrode assembly from an external stimulus.

### CROSS-REFERENCE TO RELATED APPLICATIONS

This present application claims priority to and the benefit under 35 U.S.C. § 119(a)-(d) of Korean Patent Application No. 10-2024-0022153, filed on Feb. 15, 2024, in the Korean Intellectual Property Office, the entire disclosure of which is incorporated herein by reference.

### FIELD

The present disclosure relates to a rechargeable battery.

### BACKGROUND

Unlike a primary battery, a rechargeable battery may be charged and discharged over and over again. A low-capacity rechargeable battery that includes an electrode assembly packaged in a pack may be used as a power source for various small portable electronic devices such as cellular phones and camcorders. A high-capacity rechargeable battery that has dozens of connected electrode assemblies may be used as a power source for driving motors such as in an electric scooter, a hybrid automobile, and an electric automobile.

### SUMMARY

The present disclosure provides a rechargeable battery capable of preventing damage to an electrode assembly due to an external impact.

However, the technical problem to be solved by the present disclosure is not limited to the above, and other objects not mentioned herein will be understood from the following description by those skilled in the art.

A rechargeable battery may include an electrode assembly including a first electrode plate, a second electrode plate, and a separator interposed between the first electrode plate and the second electrode plate, and a protection member having a Bouligand structure, and configured to surround the electrode assembly and protect the electrode assembly from an external stimulus.

The Bouligand structure may include a unit layer having a plurality of fiber bundle layers, each fiber bundle layer of the plurality of fiber bundle layers being rotated by a predetermined angle relative to an adjacent fiber bundle layer, such that the unit layer is rotated by a total of 180° from a top fiber bundle layer of the plurality of fiber bundle layers of the unit layer to a bottom fiber bundle layer of the plurality of fiber bundle layers of the unit layer.

The unit layer may be one of a plurality of unit layers of the Bouligand structure, the plurality of unit layers being stacked on each other.

Each fiber bundle layer of the plurality of fiber bundle layers may include chitin, which is carbohydrate.

The protection member may be coupled to the electrode assembly by heat fusion.

The protection member may comprise a tape in which an adhesive layer is disposed on a first surface of the protection member.

The protection member may be adhered to the electrode assembly by an acryl-based adhesive.

The protection member may be adhered to the electrode assembly by an SBR-based adhesive.

A thickness of the protection member may be in a range of 0.1 mm to 1 mm.

A case configured to accommodate the electrode assembly may be further included.

In some embodiments, there is provided a method of manufacturing a rechargeable battery, comprising: providing an electrode assembly comprising a first electrode plate, a second electrode plate, and a separator interposed between the first electrode plate and the second electrode plate; and coupling a protection member to the electrode assembly such that the protection member surrounds the electrode assembly, the protection member having a Bouligand structure and configured to protect the electrode assembly from an external stimulus.

In some embodiments, the Bouligand structure comprises a unit layer having a plurality of fiber bundle layers, each fiber bundle layer of the plurality of fiber bundle layers being rotated by a predetermined angle relative to an adjacent fiber bundle layer, such that the unit layer is rotated by a total of 180° from a top fiber bundle layer of the plurality of fiber bundle layers of the unit layer to a bottom fiber bundle layer of the plurality of fiber bundle layers of the unit layer.

In some embodiments, the unit layer is one of a plurality of unit layers of the Bouligand structure, the plurality of unit layers being stacked on each other.

In some embodiments, each fiber bundle layer of the plurality of fiber bundle layers comprises chitin, which is carbohydrate.

In some embodiments, coupling the protection member to the electrode assembly comprises coupling the protection member to the electrode assembly by heat fusion.

In some embodiments, wherein the protection member comprises a tape in which an adhesive layer is disposed on a first surface of the protection member.

In some embodiments, coupling the protection member to the electrode assembly comprises adhering the protection member to the electrode assembly by an acryl-based adhesive.

In some embodiments, coupling the protection member to the electrode assembly comprises adhering the protection member to the electrode assembly by an SBR-based adhesive.

In some embodiments, a thickness of the protection member is in a range of 0.1 mm to 1 mm.

In some embodiments, there is provided a protection member for an electrode assembly, the protection member comprising: a body having a Bouligand structure, and configured to surround the electrode assembly and protect the electrode assembly from an external stimulus.

In a rechargeable battery according to an embodiment, a protection member formed in a Bouligand structure is employed, and thereby even if an impact exceeding a critical point is applied to th e rechargeable battery to damage the case, the damage of the electrode assembly may be prevented. Accordingly, the risk of ignition, rupture, and explosion of the rechargeable battery can be reduced, and the safety of the rechargeable battery can be significantly improved.

### BRIEF DESCRIPTION OF THE DRAWINGS

FIG. 1 is a perspective view showing a rechargeable battery according to an embodiment.

FIG. 2 is a picture of an interior of a protection member included in the rechargeable battery of FIG. 1 photographed by using an electron microscope.

FIG. 3 is a drawing representing a Bouligand structure of the protection member of FIG. 2 in a simple diagram.

### DETAILED DESCRIPTION

Hereinafter, embodiments of the technology will be described in detail with reference to the accompanying drawings. It should be understood that terms and words used in the specification and the appended claims should be interpreted as having meanings and concepts corresponding to technical ideas of the present disclosure in view of the principle that the inventor can properly define the concepts of the terms and words in order to describe his/her own invention as best as possible. Accordingly, since the embodiment described in the specification and the configurations shown in the drawings are merely the most preferable embodiment and configurations of the present invention, they do not represent all of the technical ideas of the present invention, and it should be understood that that various equivalents and modified examples, which may replace the embodiments, are possible when filing the present application.

It will be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

In addition, in order to help understanding of the present disclosure, the accompanying drawings are not drawn to scale, and the dimensions of some components may be exaggerated. In addition, the same reference numerals may be assigned to the same elements in different embodiments.

When it is explained that two objects are ‘identical’, this means that these objects are ‘substantially identical’. Accordingly, the substantially identical objects may include deviations considered low in the art, for example, deviations within 5%. In addition, when it is explained that certain parameters are uniform in a predetermined region, this may mean that the parameters are uniform in terms of an average in the corresponding region.

Although the terms “first”, “second”, and the like are used to describe various elements, these elements are not limited by these terms. These terms are used to distinguish one element from another, and unless stated to the contrary, a first element may be a second element.

Throughout the specification, unless stated otherwise, each element may be singular or plural.

When an element is “above (or under)” or “on (or below)” another element, the element can be on an upper surface (or a lower surface) of the other element, and intervening elements may be present between the element and the other element on (or below) the element.

In addition, when an element is referred to as being “connected”, “coupled” or “linked” to another element, the element can be directly connected or coupled to the other element, but it should be understood that intervening elements may be present between each element, or each element may be “connected”, “coupled” or “linked” to each other through another element.

A term “and/or” used herein includes any one or all combinations of the associated listed items. In addition, the use of “may” when describing the embodiments of the present disclosure relates to “one or more embodiments of the present disclosure”. Expressions such as “one or more” and “one or more” preceding a list of elements may modify the entire list of elements and may not modify individual elements of the list.

Throughout the specification, when referring to “A and/or B”, it indicates A, B, or A and B, unless specifically stated to the contrary, and when referring to “C to D”, it indicates C or higher and D or lower, unless specifically stated to the contrary.

A phrase may refer to any and all suitable combinations when the phrase such as “at least one of A, B and C”, “at least one of A, B or C”, “at least one selected from the group A, B and C” or “at least one selected from A, B and C” is used to specify a list of the elements A, B, and C.

A term “use” may be considered synonymous with a term “utilize”. As used herein, a term “substantially,” “about,” or a similar term may be used as a term of approximation rather than a term of degree, and used to consider an inherent variation in a measured or calculated value which is to be recognized by those skilled in the art.

Although the terms first, second, third, or the like may be used herein to describe various elements, components, regions, layers and/or sections, these elements, components, regions, layers and/or sections should not be limited by these terms. This term may be used to distinguish one element, component, region, layer or cross section from another element, component, region, layer or cross section. Accordingly, a first element, component, region, layer, or section discussed below may be named a second element, component, region, layer, or section without departing from the teachings of the embodiments.

For ease of explanation, a spatial relative term such as “beneath,” “below,” “lower,” “above,” “upper,” or the like may be used herein in order to describe a relationship between one element or feature and another element(s) or feature(s), as shown in the drawings. Spatial relative position is to be understood to encompass different directions of a device in use or operation in addition to directions shown in the drawings. For example, when the device in the drawing is turned over, an element described as “below” or “on bottom of” another element may be understood to be “on top of” or “above” another element. Therefore, the term “below” may encompass both upward and downward directions.

The terms used herein are intended to describe the embodiments of the present disclosure and are not intended to limit the present disclosure.

Hereinafter, a rechargeable battery according to embodiments of the present disclosure will be described in detail with reference to the drawings.

The rechargeable battery may be manufactured in various shapes, including a pouch. A pouch battery may include an electrode assembly including an insulating separator interposed between a positive electrode plate and a negative electrode plate, and a thin flexible pouch in which the electrode assembly is embedded or a can formed of a metal. The pouch accommodates the electrode assembly in the inner space.

Rechargeable batteries may ignite due to evaporation or combustion of the electrolyte if the packaging material, such as a pouch or can, is damaged due to an external impact. Accordingly, research is continuing to improve the rigidity of packaging materials, but there is a limit to preventing damage to packaging materials only through the rigidity of the packaging materials due to impacts that exceed the critical point.

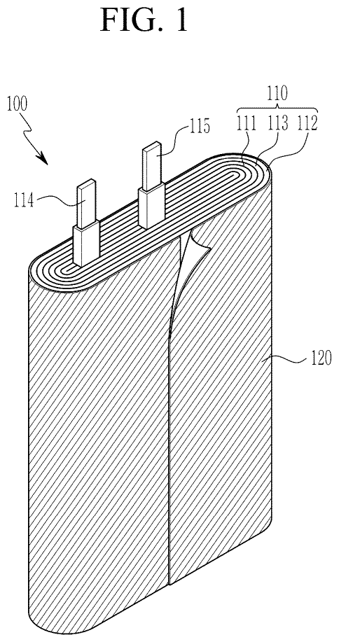

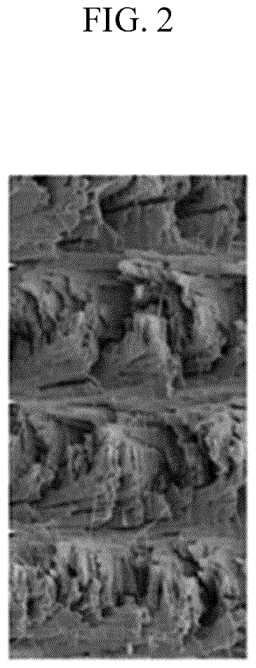

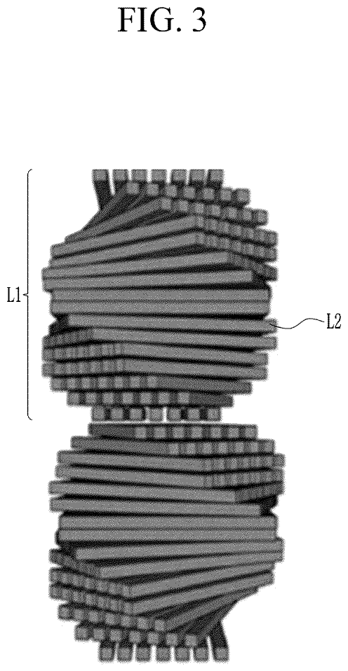

FIG. 1 is a perspective view showing a rechargeable battery according to an embodiment. FIG. 2 is a picture of an interior of a protection member included in the rechargeable battery of FIG. 1 photographed by using an electron microscope. FIG. 3 is a drawing representing a Bouligand structure of the protection member of FIG. 2 in a simple diagram.

Referring to FIG. 1 to FIG. 3, a rechargeable battery 100 according to an embodiment may include an electrode assembly 110 and a protection member 120.

The electrode assembly 110 may include a first electrode plate 111, a second electrode plate 112 and a separator 113. The electrode assembly 110 may be in the form of a laminate including the first electrode plate 111, the second electrode plate 112, and the separator 113 being repeatedly wound or stacked.

For example, the electrode assembly 110 may be of a repeatedly wound jelly-roll type. Alternatively, there may be a plurality of electrode assemblies 110, and the plurality of electrode assemblies 110 may be of a stacked type disposed to be stacked in multiple layers. In the present disclosure, the electrode assembly 110 of the stacked type will be described as an example.

Each of the first electrode plate 111 and the second electrode plate 112 may include electrode base tabs 114 and 115 disposed to be exposed to the outside of the electrode assembly 110. The first electrode plate 111 may include a first electrode base tab 114, and the second electrode plate 112 may include a second electrode base tab 115.

Meanwhile, the second electrode plate 112 may be a negative electrode, and the first electrode plate 111 may be a positive electrode. In other embodiments, the second electrode plate 112 may be a positive electrode and the first electrode plate 111 may be a negative electrode.

The first electrode plate 111, which is a positive electrode in the illustrated embodiments, may be one in which an electrode active material such as transition metal oxide is applied to an electrode current collector manufactured as a metal foil such as aluminum or aluminum alloy.

The second electrode plate 112, which is a negative electrode in the illustrated embodiments, may be manufactured by applying an electrode active material such as graphite or carbon to an electrode current collector manufactured as a metal foil such as copper, copper alloy, nickel or nickel alloy.

The separator 113 may be interposed between the first electrode plate 111 and the second electrode plate 112. The separator 113 may prevent a short circuit of the first electrode plate 111 and the second electrode plate 112, and enable the movement of lithium ions. To this end, the separator 113 may be formed in a relatively greater size than the first electrode plate 111 and the second electrode plate 112.

The material of the separator 113 may be, for example, polyethylene, polypropylene, or a composite film of polyethylene and polypropylene, but is not limited thereto.

The separator 113 may be cut into unit lengths and disposed between the first electrode plate 111 and the second electrode plate 112. Alternatively, a single the separator 113 in a ribbon shape may be disposed between the first electrode plate 111 and the second electrode plate 112 in a zigzag shape. Alternatively, the separator 113 may be installed to be wound in one direction between the first electrode plate 111 and the second electrode plate 112.

Although the arrangement form of the separator 113 is not limited to a particular form, in the present embodiment, for convenience of description, it is supposed that the separator 113 is installed to wind the area between the first electrode plate 111 and the second electrode plate 112 in the first direction.

Although not shown in the drawings, the electrode assembly 110 may be accommodated in a case (not shown) together with an electrolyte solution. The case may be a pouch or can, and detailed description on the case may be omitted.

The protection member 120 may be formed in a Bouligand structure, and may surround the electrode assembly 110. The protection member 120 may protect the electrode assembly 110 from an external stimulus. A thickness of the protection member 120 may be included in a range of 0.1 mm to 1 mm.

When the thickness of the protection member 120 exceeds 1 mm, a thickness of the electrode assembly 110 may be excessively increased. On the other hand, when the thickness of the protection member 120 is less than 0.1 mm, the protection member 120 may be excessively thin, such that the impact applied from the outside may not be absorbed.

As a bonding method of the protection member 120 and the electrode assembly 110, for example, a method using heat fusion may be used. Alternatively, the protection member 120 may be adhered to the electrode assembly 110 by an acryl-based adhesive. Alternatively, the protection member 120 may be adhered to the electrode assembly 110 by styrene butadiene rubber (SBR)-based adhesive. On the other hand, the protection member 120 may be a tape in which an adhesive layer exists on a first surface.

As shown in FIG. 3, the Bouligand structure includes a unit layer L1 in which a plurality of fiber bundle layers L2 is disposed to rotate 180° from a lower end to an upper end (e.g., from a top fiber bundle layer to a bottom fiber bundle layer). For example, the Bouligand structure may include a unit layer having a plurality of fiber bundle layers. Each fiber bundle layer of the plurality of fiber bundle layers may be rotated by a predetermined angle relative to an adjacent fiber bundle layer. The unit layer may be rotated by a total of 180° from a top fiber bundle layer of the plurality of fiber bundle layers of the unit layer to a bottom fiber bundle The unit layer L1 is provided in a plural quantity, and a plurality of unit layers are stacked on each other. Here, the fiber bundle layer L2 may include chitin which is carbohydrate.

Chitin is a white, amorphous powder. Chitin has very similar chemical structure and physical properties to cellulose, so it can be considered similar to cellulose, however, chitin is weakly reactive and does not dissolve well in water, and is much more stable than cellulose.

The Bouligand structure is a fine structure that consists of layers similar to plywood and rotates in one direction. The Bouligand structure consists of several lamellae, or layers, in which each layer is made up of aligned fibers. Adjacent lamellae are gradually rotated relative to neighboring lamellae. This Bouligand structure improves the material's mechanical properties, especially fracture resistance, and enables strength and planar isotropy.

This Bouligand structure can be manufactured from thin materials and is very superior to general materials in terms of toughness and impact resistance. That is, the protection member 120 of the Bouligand structure can mechanically compensate for the weak mechanical properties of the electrode assembly 110 of the rechargeable battery 100.

Hereinafter, it will be confirmed through an impact experiment that the mechanical properties of the rechargeable battery 100 according to an embodiment are improved compared to a conventional rechargeable battery.

The rechargeable battery 100 according to an embodiment may include a protective member 120 with a thickness of 0.3 mm, and the rechargeable battery 100 according to the Comparative Example does not include the protective member 120.

In the impact experiment, a 1 kg weight was dropped onto the rechargeable battery 100 from a height of 1 m. In 10 impact experiments, the electrode assembly 110 of the rechargeable battery 100 according to the Comparative Example was damaged all 10 times and ignition occurred. However, in the rechargeable battery 100 according to the embodiment, a portion of the electrode assembly 110 was pressed all 10 times, but no ignition occurred.

Through the above impact experiment, it can be confirmed that the rechargeable battery 100 according to an embodiment has improved resistance to external shocks compared to a conventional rechargeable battery.

The rechargeable battery 100 according to an embodiment includes a protection member 120 made of a Bouligand structure, so that the electrode assembly 110 is protected even if the case is damaged when an impact exceeding the critical point is applied to the rechargeable battery 100. Accordingly, the risk of ignition, rupture, and explosion of the rechargeable battery 100 can be reduced, and thus the safety of the rechargeable battery 100 can be significantly improved.

In some embodiments, there is provided a method of manufacturing a rechargeable battery, comprising: providing an electrode assembly comprising a first electrode plate, a second electrode plate, and a separator interposed between the first electrode plate and the second electrode plate; and coupling a protection member to the electrode assembly such that the protection member surrounds the electrode assembly, the protection member having a Bouligand structure and configured to protect the electrode assembly from an external stimulus.

In some embodiments, the Bouligand structure comprises a unit layer having a plurality of fiber bundle layers, each fiber bundle layer of the plurality of fiber bundle layers being rotated by a predetermined angle relative to an adjacent fiber bundle layer, such that the unit layer is rotated by a total of 180° from a top fiber bundle layer of the plurality of fiber bundle layers of the unit layer to a bottom fiber bundle layer of the plurality of fiber bundle layers of the unit layer.

In some embodiments, the unit layer is one of a plurality of unit layers of the Bouligand structure, the plurality of unit layers being stacked on each other.

In some embodiments, each fiber bundle layer of the plurality of fiber bundle layers comprises chitin, which is carbohydrate.

In some embodiments, coupling the protection member to the electrode assembly comprises coupling the protection member to the electrode assembly by heat fusion.

In some embodiments, wherein the protection member comprises a tape in which an adhesive layer is disposed on a first surface of the protection member.

In some embodiments, coupling the protection member to the electrode assembly comprises adhering the protection member to the electrode assembly by an acryl-based adhesive.

In some embodiments, coupling the protection member to the electrode assembly comprises adhering the protection member to the electrode assembly by an SBR-based adhesive.

In some embodiments, a thickness of the protection member is in a range of 0.1 mm to 1 mm.

In some embodiments, there is provided a protection member for an electrode assembly, the protection member comprising: a body having a Bouligand structure, and configured to surround the electrode assembly and protect the electrode assembly from an external stimulus.

While this disclosure has been described in connection with what is presently considered to be practical embodiments, the drawings and the detailed description of the present disclosure which are described above are merely illustrative, are just used for the purpose of describing the present invention, and are not used for qualifying the meaning or limiting the scope of the present disclosure, which is disclosed in the appended claims. Therefore, it will be understood by those skilled in the art that various modifications and other equivalent embodiments may be made from the present disclosure. Accordingly, an actual technical protection scope of the present disclosure is to be defined by the claims.

### DESCRIPTION OF SYMBOLS

100: rechargeable battery
110: electrode assembly
111: first electrode plate
112: second electrode plate
113: separator
120: protection member
L1: unit layer
L2: fiber bundle layer

What is claimed is:

1. A rechargeable battery, comprising:
an electrode assembly comprising a first electrode plate, a second electrode plate, and a separator interposed between the first electrode plate and the second electrode plate; and
a protection member having a Bouligand structure, and configured to surround the electrode assembly and protect the electrode assembly from an external stimulus.

2. The rechargeable battery of claim 1, wherein the Bouligand structure comprises a unit layer having a plurality of fiber bundle layers, each fiber bundle layer of the plurality of fiber bundle layers being rotated by a predetermined angle relative to an adjacent fiber bundle layer, such that the unit layer is rotated by a total of 180° from a top fiber bundle layer of the plurality of fiber bundle layers of the unit layer to a bottom fiber bundle layer of the plurality of fiber bundle layers of the unit layer.

3. The rechargeable battery of claim 2, wherein the unit layer is one of a plurality of unit layers of the Bouligand structure, the plurality of unit layers being stacked on each other.

4. The rechargeable battery of claim 2, wherein each fiber bundle layer of the plurality of fiber bundle layers comprises chitin, which is carbohydrate.

5. The rechargeable battery of claim 1, wherein the protection member is coupled to the electrode assembly by heat fusion.

6. The rechargeable battery of claim 1, wherein the protection member comprises a tape in which an adhesive layer is disposed on a first surface of the protection member.

7. The rechargeable battery of claim 1, wherein the protection member is adhered to the electrode assembly by an acryl-based adhesive.

8. The rechargeable battery of claim 1, wherein the protection member is adhered to the electrode assembly by an SBR-based adhesive.

9. The rechargeable battery of claim 1, wherein a thickness of the protection member is in a range of 0.1 mm to 1 mm.

10. The rechargeable battery of claim 1, further comprising a case configured to accommodate the electrode assembly.

11. A method of manufacturing a rechargeable battery, comprising:
providing an electrode assembly comprising a first electrode plate, a second electrode plate, and a separator interposed between the first electrode plate and the second electrode plate; and
coupling a protection member to the electrode assembly such that the protection member surrounds the electrode assembly, the protection member having a Bouligand structure and configured to protect the electrode assembly from an external stimulus.

12. The method of claim 11, wherein the Bouligand structure comprises a unit layer having a plurality of fiber bundle layers, each fiber bundle layer of the plurality of fiber bundle layers being rotated by a predetermined angle relative to an adjacent fiber bundle layer, such that the unit layer is rotated by a total of 180° from a top fiber bundle layer of the plurality of fiber bundle layers of the unit layer to a bottom fiber bundle layer of the plurality of fiber bundle layers of the unit layer.

13. The method of claim 12, wherein the unit layer is one of a plurality of unit layers of the Bouligand structure, the plurality of unit layers being stacked on each other.

14. The method of claim 12, wherein each fiber bundle layer of the plurality of fiber bundle layers comprises chitin, which is carbohydrate.

15. The method of claim 11, wherein coupling the protection member to the electrode assembly comprises coupling the protection member to the electrode assembly by heat fusion.

16. The method of claim 11, wherein the protection member comprises a tape in which an adhesive layer is disposed on a first surface of the protection member.

17. The method of claim 11, wherein coupling the protection member to the electrode assembly comprises adhering the protection member to the electrode assembly by an acryl-based adhesive.

18. The method of claim 11, wherein coupling the protection member to the electrode assembly comprises adhering the protection member to the electrode assembly by an SBR-based adhesive.

19. The method of claim 11, wherein a thickness of the protection member is in a range of 0.1 mm to 1 mm.

20. A protection member for an electrode assembly, the protection member comprising:
a body having a Bouligand structure, and configured to surround the electrode assembly and protect the electrode assembly from an external stimulus.
